(19) United States
(12) Patent Application Publication
(10) Pub. No.: US 2017/0345568 A1
(43) Pub. Date: Nov. 30, 2017

(54) MULTILAYER CERAMIC CAPACITOR

(71) Applicant: TAIYO YUDEN CO., LTD., Tokyo (JP)

(72) Inventors: Katsuo SAKATSUME, Takasaki-shi (JP); Masumi ISHII, Takasaki-shi (JP); Takeshi NOSAKI, Takasaki-shi (JP); Norihiro ARAI, Takasaki-shi (JP); Jyouji ARIGA, Takasaki-shi (JP); Yasushi INOUE, Takasaki-shi (JP)

(21) Appl. No.: 15/457,214

(22) Filed: Mar. 13, 2017

(30) Foreign Application Priority Data
May 31, 2016 (JP) 2016-109160

(51) Int. Cl. H01G 4/30; H01G 4/012; H01G 4/12; H01G 4/232

(52) U.S. Cl. CPC H01G 4/30; H01G 4/2325; H01G 4/012; H01G 4/1236

(57) ABSTRACT

A multilayer ceramic capacitor includes: a ceramic multilayer structure having ceramic dielectric layers and internal electrode layers alternately stacked, the internal electrode layers being mainly composed of a transition metal other than an iron group, end edges of the internal electrode layers being alternately exposed to a first end face and a second end face; and at least a pair of external electrodes that are provided on the first face and the second face of the ceramic multilayer structure, wherein the external electrode includes a base conductive layer including ceramic of 5 weight % or less and being mainly composed of a transition metal other than an iron group or a noble metal and a first plated film having a thickness that is half of a thickness of the base conductive layer or more and being mainly composed of a transition metal other than an iron group.

### CROSS-REFERENCE TO RELATED APPLICATION

This application is based upon and claims the benefit of priority of the prior Japanese Patent Application No. 2016-109160, filed on May 31, 2016, the entire contents of which are incorporated herein by reference.

### FIELD

A certain aspect of the present invention relates to a multilayer ceramic capacitor.

### BACKGROUND

Japanese Patent Application Publication No. 2001-274035 discloses a technology in which a conductive paste for external electrodes including a conductive component and a glass frit of which amount is 5 to 50 weight % with respect to total of the conductive component and the glass frit is used in order to prevent intrusion of a plating solution, in a multilayer ceramic capacitor including a base metal such as Cu, Ni or the like for internal electrodes and external electrodes.

When an external electrode paste lacks ceramic such as a co-material or a glass, a problem may occur in a seal property of a chip. Alternatively, when an excessive amount of ceramic is added, inferior plating may occur after sintering of a metal. And so, Japanese Patent Application Publication No. 2013-048231 discloses a technology for solving the problems, in which an external electrode paste includes conductive metal grains having an average grain size of 0.3 μm or less by 10 to 90 weight part and an amount of glass with respect to the conductive metal grains is 0.3 to 2.0. On the other hand, Japanese Patent Application Publication No. 2014-011449 discloses a technology for solving the problems, in which an average of a longitudinal length of glass included in an external electrode is 10 μm or less.

### SUMMARY OF THE INVENTION

According to an aspect of the present invention, there is provided a multilayer ceramic capacitor including: a ceramic multilayer structure designated to have ceramic dielectric layers and internal electrode layers alternately stacked, the internal electrode layers being mainly composed of a transition metal other than an iron group, end edges of the internal electrode layers being alternately exposed to a first end face and a second end face of the ceramic multilayer structure; and at least a pair of external electrodes that are provided on the first face and the second face of the ceramic multilayer structure, wherein the external electrode includes a base conductive layer directly contacting the ceramic multilayer structure and a first plated film covering the base conductive layer, the base conductive layer including ceramic of 5 weight % or less and being mainly composed of a transition metal other than an iron group or a noble metal, the first plated film having a thickness that is half of a thickness of the base conductive layer or more and being mainly composed of a transition metal other than an iron group.

### BRIEF DESCRIPTION OF THE DRAWINGS

FIG. 1A and FIG. 1B illustrate a multilayer ceramic capacitor in accordance with an embodiment;

FIG. 2 is a flowchart illustrating a method of manufacturing a multilayer ceramic capacitor;

FIG. 3 illustrates characteristic results of examples; and

FIG. 4 illustrates characteristic results of comparative examples.

### DETAILED DESCRIPTION

When an under electrode includes ceramic, a moisture component remains in a void generated because of dropping of the ceramic, elution of the ceramic into a plating solution, or remaining of pores caused by condensation. In this case, a solder splitting phenomenon tends to occur. In order suppress the solder splitting phenomenon, it is necessary to form a metal plated film. When affinity with respect to the solder during a mounting is considered, a Ni-plating is generally used for the metal plated film. In order to suppress the solder splitting phenomenon, it is preferable that a Ni-plated film has a large thickness. On the other hand, when electrical characteristics of a high frequency band are considered, a resistance increases because of a skin effect of the high frequency band in a case where the iron group transition metal such as Ni having a high relative permeability exists on a signal line. In this case, a dielectric loss may increase.

A description will be given of an embodiment with reference to the accompanying drawings.

### EMBODIMENT

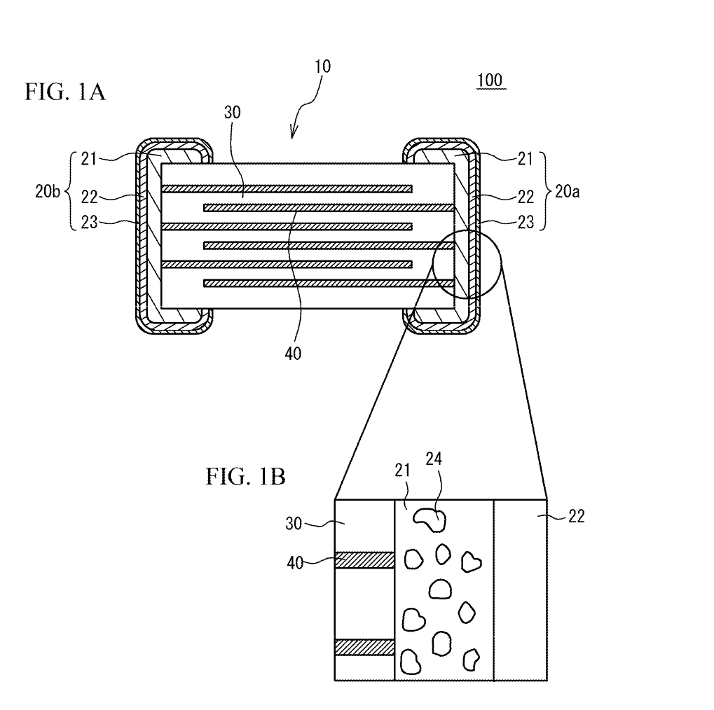

FIG. 1A and FIG. 1B illustrate a multilayer ceramic capacitor 100 in accordance with an embodiment. The multilayer ceramic capacitor 100 illustrated in FIG. 1A and FIG. 1B is one example. Therefore, the multilayer ceramic capacitor 100 may be applied to shapes other than that of FIG. 1A and FIG. 1B. The multilayer ceramic capacitor 100 may be used for an array.

As illustrated in FIG. 1A, the multilayer ceramic capacitor 100 includes a ceramic multilayer structure 10 having a rectangular parallelepiped shape, and at least a pair of external electrodes 20a and 20b. The ceramic multilayer structure 10 has a structure designed to have ceramic dielectric layers 30 and internal electrode layers 40 alternately stacked. End edges of the internal electrode layers 40 are alternately exposed to a first end face of the ceramic multilayer structure 10 and a second end face of the ceramic multilayer structure 10 that is different from the first end face. In the embodiment, the first face faces with the second face. The external electrode 20a is provided on the first end face. The external electrode 20b is provided on the second end face.

The ceramic dielectric layer 30 is mainly composed of a ceramic material having a perovskite structure expressed by a general expression ABO₃. The perovskite structure includes ABO_{3-α} having an off-stoichiometric composition. For example, the ceramic material may be CaZrO₃ (calcium zirconate), BaTiO₃ (barium titanate), CaTiO₃ (calcium titanate), SrTiO₃ (strontium titanate), Ba_{1-x-y}CaₓSr_{y}Ti_{1-z}Zr_{z}O₃ (0≦x≦1, 0≦y≦1, 0≦z≦1) having a perovskite structure and so on.

The internal electrode layer 40 is a conductive thin film that is mainly composed of a transition metal component such as Cu other than iron group (Fe, Co and Ni).

The external electrodes 20a and 20b have a base conductive layer 21, a first plated film 22 and a second plated film 23. The base conductive layer 21 directly contacts the ceramic multilayer structure 10. The first plated film 22 directly contacts the base conductive layer 21 and covers the base conductive layer 21. The second plated film 23 directly contacts the first plated film 22 and covers the first plated film 22. The base conductive layer 21 includes ceramic and is mainly composed of a transition metal such as Cu other than an iron group, or a noble metal such as Ag, Au, Pt, or Pd. A preferable high frequency characteristics can be achieved, because the base conductive layer 21 is mainly composed of the transition metal other than the iron group, or the noble metal. For example, the base conductive layer 21 has a thickness of approximately 4 μm to 10 μm.

FIG. 1B illustrates an enlarged view of the base conductive layer 21. As illustrated in FIG. 1B, ceramics 24 are dispersed in the base conductive layer 21. The ceramic 24 in the base conductive layer 21 acts as a co-material when the ceramic multilayer structure 10 and the base conductive layer 21 are calcined. Therefore a preferable sintering of the base conductive layer 21 can be achieved. When an amount of the ceramic in the base conductive layer 21 is large, discontinuity may occur in the first plated film 22. And so, the base conductive layer 21 includes the ceramic of 5 weight % or less. The ceramic is not limited specifically. It is preferable that the ceramic is not softened or melted during the calcination of the ceramic multilayer structure 10. It is therefore preferable that a ceramic other than a glass is used as the ceramic. That is, it is preferable that a crystalline ceramic is used as the ceramic. It is preferable that a ceramic having a perovskite structure is used as the ceramic, because it is preferable that the ceramic sufficiently acts as the co-material. And, it is more preferable that a perovskite ceramic having the same composition as the ceramic dielectric layer 30 is used as the ceramic.

During formation of the first plated film 22, in the base conductive layer 21, a moisture component such as a plating solution may remain in a void generated by dropping of the ceramic 24, a void generated by elution of the ceramic 24 into the plating solution during the formation of the first plated film 22, a void generated by remaining of pores caused by condensation, or the like. Thus, a solder splitting phenomenon may occur during a solder mounting of the multilayer ceramic capacitor 100. And so, the first plated film 22 has a thickness that is a half of the thickness of the base conductive layer 21 or more. In this case, the first plated film 22 has a sufficient thickness. Therefore, the solder splitting phenomenon may be suppressed. The amount of the ceramic in the base conductive layer 21 gets larger when the base conductive layer 21 is thick. In this case, for example, adjacent ceramics are combined with each other during baking, and thereby tend to form a large size grain. The large size grain becomes a factor of a large pore by dropping. It is preferable that the large pore is filled with a large thickness plated film. Therefore, when the base conductive layer 21 is thick, it is preferable that the first plated film 22 is thick. And so, an absolute value of the thickness of the first plated film 22 is not regulated. However, the first plated film 22 has the thickness that is half of the thickness of the base conductive layer 21 or more, as a relative value with respect to the thickness of the base conductive layer 21.

When an affinity with respect to the solder used for the mounting of the multilayer ceramic capacitor 100 is considered, it is preferable that a Ni-plating is used for the formation of the first plated film 22. However, when electrical characteristic of a high frequency band is considered, a resistance increases because of a skin effect of the high frequency band in a case where the iron group transition metal such as Ni having a high relative permeability exists on a signal line. In this case, a dielectric loss may increase. And so, in the embodiment, the transition metal such as Cu other than the iron group is used as the main component of the first plated film 22. It is therefore possible to reduce the dielectric loss in the high frequency band.

The second plated film 23 is mainly composed of another transition metal other than the iron group that is different from the transition metal of the first plated film 22. For example, when the affinity with respect to the solder used for the mounting of the multilayer ceramic capacitor 100 is considered, it is preferable that the second plated film 23 is mainly composed of a transition metal such as Sn.

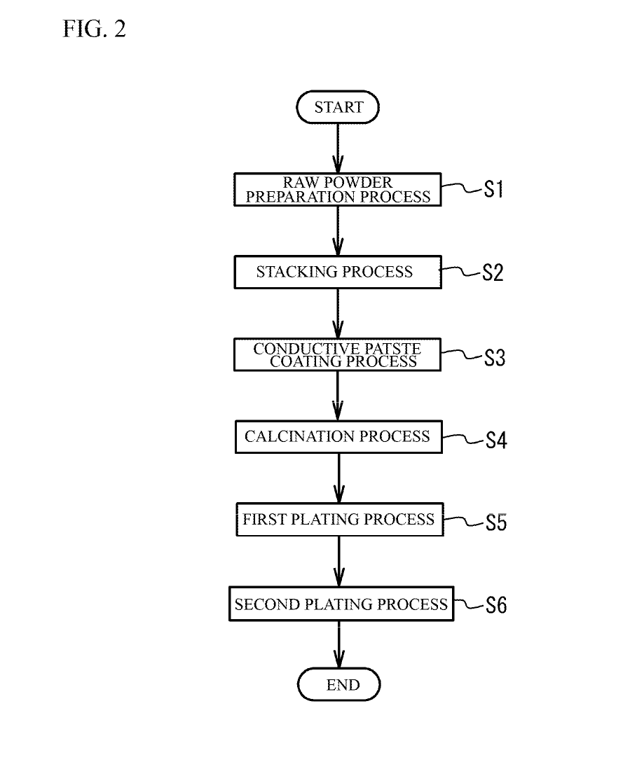

A description will next be given of a manufacturing method of the multilayer ceramic capacitor 100. FIG. 2 is a flowchart illustrating a method of manufacturing the multilayer ceramic capacitor 100.

### Raw Powder Preparation Process

First, specified additive compounds may be added to ceramic material powder that is the main component of the ceramic dielectric layer 30 according to the purpose. The examples of the additive compounds include Mg, Mn, V, Cr, oxidation materials of rare-earth elements (Y, Dy, Tm, Ho, Tb, Yb, and Er), and oxidation materials of Sm, Eu, Gd, Co, Ni, Li, B, Na, K, and Si, or glass. For example, a compound including the additive compounds is added to the ceramic material powder, and the resulting compound is calcined. Next, the resulting ceramic material grains are wet-blended with the additive compound, dried and ground to prepare ceramic material powder.

Next, a binder such as polyvinyl butyral (PVB) resin, an organic solvent such as ethanol or toluene, and a plasticizer such as dioctyl phthalate (DOP) are added to the resulting ceramic material powder and wet-blended. With use of the resulting slurry, a strip-shaped dielectric green sheet substance with a thickness of 0.8 μm or less is coated on a base material by, for example, a die coater method or a doctor blade method, and then dried.

### Stacking Process

Then, a conductive paste for the internal electrode is printed on the surface of the dielectric green sheet by screen printing or gravure printing to arrange patterns of the internal electrode layers 40. The conductive paste for the internal electrode includes powder of the main component metal of the internal electrode layer 40, a binder, a solvent and an auxiliary agent as needed. It is preferable that the binder and the solvent are different from those of the ceramic slurry. The ceramic material that is the main component of the ceramic dielectric layer 30 may be dispersed into the conductive paste for the internal electrode, as a co-material.

Then, the dielectric green sheet on which the internal electrode layer pattern is printed is stamped into a predetermined size, and a predetermined number (for example, 200 to 500) of stamped dielectric green sheets are stacked while the base material is peeled so that the internal electrode layers 40 and the ceramic dielectric layers 30 are alternated with each other and the end edges of the internal electrode layers 40 are alternately exposed to both end faces in the length direction of the dielectric layer so as to be alternately led out to a pair of external electrodes of different polarizations. Thereby, a layered product having a rectangular parallelepiped shape is obtained. Dielectric green sheet, which are to be the cover layers, are stacked on the layered product and under the layered product.

### Coating Process

Next, a conductive paste for the base conductive layer is coated on the two edge faces to which the internal electrode patterns of the resulting multilayer structure are exposed. Thus, a compact is obtained. The conductive paste for the base conductive layer includes powder of the main component metal of the base conductive layer 21, a binder, a solvent, and an auxiliary agent as needed. The binder and the solvent may be the same as those of the conductive paste for the internal electrode. And a ceramic material that is the main component of the ceramic dielectric layer 30 is dispersed in the conductive paste for the base conductive layer as a co-material. The amount of the ceramic material in the conductive paste for the base conductive layer is 5 weight % or less.

### Calcination Process

Next, the resulting compact is calcined for approximately two hours at a temperature of approximately 950 degrees C. in a reducing atmosphere of which H₂ volume % is approximately 1.5. In this case, it is possible to perform the calcination of the ceramic dielectric layer 30 and the internal electrode layer 40 and the baking of the base conductive layer 21 at the same process. And, a semi-product of the multilayer ceramic capacitor 100 can be obtained.

### First Plating Process and Second Plating Process

Next, the first plated film 22 is formed on the base conductive layer 21 of the semi-product by an electrolytic plating. In the process, the electrolytic plating is performed so that the thickness T of the first plated film 22 satisfies a relation of t/2≦T with respect to the thickness t of the base conductive layer 21. In order to suppress the grown in size of the multilayer ceramic capacitor 100, it is preferable that the thickness t is adjusted to satisfy a relation of t/2≦T≦t. Moreover, the second plated film 23 is formed on the first plated film 22.

In the embodiment, the base conductive layer 21 includes the ceramic of 5 weight % or less. In this case, it is possible to suppress the discontinuity of the first plated film 22 and achieve the preferable sintering of the base conductive layer 21. On the other hand, in order to suppress the crack of the base conductive layer 21, it is preferable that the amount of the ceramic in the base conductive layer 21 has a lower limit. And so, it is preferable that the amount of the ceramic in the base conductive layer 21 is 3 weight % or more. In this case, the preferable sintering is achieved. It is therefore possible to suppress the crack. And, the first plated film 22 has the thickness T satisfying the relation of t/2≦T with respect to the thickness t of the base conductive layer 21. Therefore, the first plated film 22 is sufficiently thick. Thus, the solder splitting phenomenon can be suppressed. In order to reduce the size of the multilayer ceramic capacitor 100, it is preferable that the thickness T satisfies the relation of t/2≦T≦t. The base conductive layer 21 is mainly composed of the transition metal other than the iron group or the noble metal. And, the first plated film 22 and the second plated film 23 are mainly composed of the transition metal other than the iron group. Therefore, the dielectric loss in the high frequency band can be reduced.

### EXAMPLES

The multilayer ceramic capacitors were manufactured in accordance with the embodiment. And characteristic of the multilayer ceramic capacitors was measured.

### Examples 1 to 11

The multilayer ceramic capacitors 100 were manufactured in accordance with the embodiment.

CaZrO₃ was used as the ceramic material that is the main component of the ceramic dielectric layer 30. A molar ratio of Zr to Ca (Ca/Zr) was 1.05. BN (3.5 mol %), SiO₂ (3.5 mol %), Li₂CO₃ (1.75 mol %) and MnCO₃ (3.5 mol %) were added to the ceramic dielectric layer 30 as the additive material. Cu was used as the main component of the internal electrode layer 40. Cu was used as the main component of the base conductive layer 21 of the external electrodes 20a and 20b. CaZrO₃ was added to the base conductive layer 21 by 3 to 5 weight part as the co-material. Cu was used as the first plated film 22. In any of the examples 1 toll, the thickness of the first plated film 22 is half of the thickness of the base conductive layer 21 or more. Sn was used as the second plated film 23. In any of the examples 1 to 11, the thickness of the second plated film 23 was 2.5 μm.

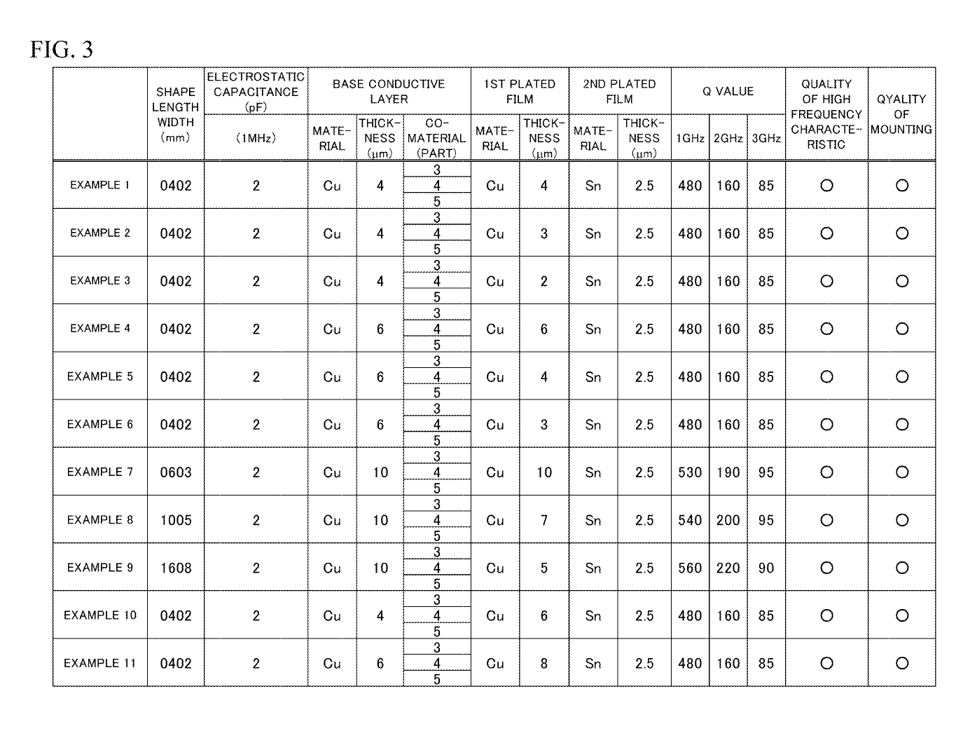

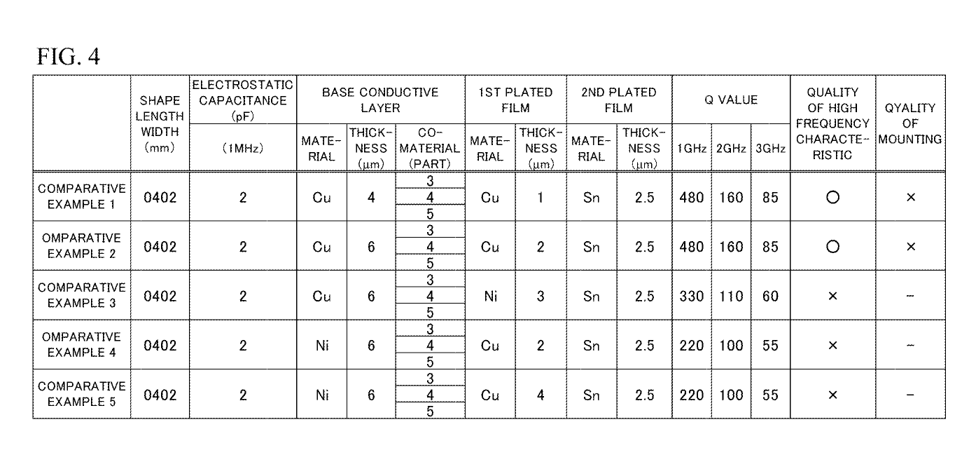

FIG. 3 and FIG. 4 illustrate an approximate shape, an electrostatic capacitance, a thickness of the base conductive layer 21, a thickness of the first plated film 22, a thickness of the second plated film 23, high frequency characteristic (Q value), quality of high frequency characteristic and mounting quality of the multilayer ceramic capacitor 100. When the solder splitting phenomenon did not occur during the solder mounting of the multilayer ceramic capacitor 100, the mounting quality is “◯”. When the solder splitting phenomenon occurred, the mounting quality is “X”.

In a comparative example 1, the thickness of the base conductive layer 21 was 4 μm. The thickness of the first plated film 22 was 1 μm. Other conditions were the same as those of the examples 1 to 11.

In a comparative example 2, the thickness of the base conductive layer 21 was 6 μm. The thickness of the first plated film 22 was 2 Other conditions were the same as those of the examples 1 to 11.

In a comparative example 3, the thickness of the base conductive layer 21 was 6 μm. The thickness of the first plated film 22 was 3 μm. Ni was used as the first plated film 22. Other conditions were the same as those of the examples 1 to 11.

In a comparative example 4, the thickness of the base conductive layer 21 was 6 μm. The thickness of the first plated film 22 was 2 μm. Ni was used as the base conductive layer 21. Other conditions were the same as those of the examples 1 to 11.

In a comparative example 5, the thickness of the base conductive layer 21 was 6 μm. The thickness of the first plated film 22 was 4 μm. Ni was used as the base conductive layer 21. Other conditions were the same as those of the examples 1 to 11.

As illustrated in FIG. 3, in any of the examples 1 to 11, the preferable mounting characteristic is achieved. This is because the thickness of the first plated film 22 was half of that of the base conductive layer 21 or more and the first plated film 22 was sufficiently thick. And the preferable high frequency characteristic is achieved in the examples 1 to 11. This is because the transition metal (Cu) other than the iron group transition metal was used as the base conductive layer 21, the first plated film 22 and the second plated film 23.

On the other hand, as illustrated in FIG. 4, in the comparative examples 1, 2 and 4, the solder splitting phenomenon occurred during the solder mounting. This is because the thickness of the first plated film 22 was less than half of the thickness of the base conductive layer 21, the thickness of the first plated film 22 was not sufficiently thick, and the remaining of a moisture component in the void generated in the base conductive layer 21 was not suppressed.

Next, in the examples 1 to 11, the preferable high frequency characteristic is achieved. This is because the transition metal (Cu) other than the iron group transition metal was used as the base conductive layer 21 and the first plated film 22.

On the other hand, in the comparative examples 3 to 5, the preferable high frequency characteristic is not achieved. This is because the iron group transition metal Ni was used as one of the base conductive layer 21 and the first plated film 22.

Although the embodiments of the present invention have been described in detail, it is to be understood that the various change, substitutions, and alterations could be made hereto without departing from the spirit and scope of the invention.

What is claimed is:

1. A multilayer ceramic capacitor comprising:
a ceramic multilayer structure designated to have ceramic dielectric layers and internal electrode layers alternately stacked, the internal electrode layers being mainly composed of a transition metal other than an iron group, end edges of the internal electrode layers being alternately exposed to a first end face and a second end face of the ceramic multilayer structure; and
at least a pair of external electrodes that are provided on the first face and the second face of the ceramic multilayer structure,
wherein the external electrode includes a base conductive layer directly contacting the ceramic multilayer structure and a first plated film covering the base conductive layer, the base conductive layer including ceramic of 5 weight % or less and being mainly composed of a transition metal other than an iron group or a noble metal, the first plated film having a thickness that is half of a thickness of the base conductive layer or more and being mainly composed of a transition metal other than an iron group.

2. The multilayer ceramic capacitor as claimed in claim 1, wherein ceramic of the base conductive layer is mainly composed of CaZrO₃.

3. The multilayer ceramic capacitor as claimed in claim 1, wherein the ceramic dielectric layer is mainly composed of CaZrO₃.

4. The multilayer ceramic capacitor as claimed in claim 1, further comprising a second plated film that covers the first plated film, and is mainly composed of a transition metal, other than the iron group, that is different from the transition metal of the first plated film.

5. The multilayer ceramic capacitor as claimed in claim 4, wherein:
the base conductive layer and the first plated film are mainly composed of Cu; and
the second plated film is mainly composed of Sn.
